(19) United States
(12) Patent Application Publication
(10) Pub. No.: US 2020/0366124 A1
(43) Pub. Date: Nov. 19, 2020

(54) MOBILE COMMUNICATION DEVICE PROTECTION AND CHARGING STAND OR TABLE (SUNTABLE)

(71) Applicant: Shadecraft, Inc., Pasadena, CA (US)

(72) Inventor: Armen Gharabegian, Glendale, CA (US)

(73) Assignee: Shadecraft, Inc.

(21) Appl. No.: 16/736,657

(22) Filed: Jan. 7, 2020

Related U.S. Application Data
(60) Provisional application No. 62/887,568, filed on Aug. 15, 2019.
(60) Provisional application No. 62/789,182, filed on Jan. 7, 2019.

(51) Int. Cl. H02J 7/35; H02J 50/00; H02J 50/10; H02J 7/00

(52) U.S. Cl. CPC H02J 7/35; H02J 50/005; H04R 1/028; H02J 7/0044; H02J 7/0045; H02J 50/10

(57) ABSTRACT

A mobile communication device charging apparatus, comprising a base assembly, a central support assembly connected to the base assembly, an electronics housing connected to the central support assembly; a speaker housing connected to the electronics housing; a shelf assembly connected to the speaker housing, and a table assembly connected to the shelf assembly. The table assembly includes one or more solar cells or arrays, the one or more solar cells or arrays to capture sunlight in order to generate power for the charging apparatus. The shelf assembly includes an opening and a lower surface, the lower surface including inductive charging assemblies to charge a mobile communication device placed thereon. The top surface of the shelf assembly protects the mobile communication device from sunlight when the mobile communication device is placed on the lower surface.

### RELATED APPLICATIONS

This application claims priority to provisional patent application Ser. No. 62/789,182, filed Jan. 7, 2019, entitled “Parasol Solar Shelf” and provisional patent application Ser. No. 62/887,568, filed Aug. 15, 2019, entitled “Mobile Communication Device Protection And Charging Stand Or Table (Suntable),” the disclosures of which are hereby incorporated by reference.

### BACKGROUND

There are many places having charging apparatus or devices indoors. However, a need exists for providing charging for mobile communication devices in outdoor areas.

### BRIEF DESCRIPTION OF DRAWINGS

FIG. 1 illustrates a mobile communication device charging and protection stand or table according to some embodiments;

FIG. 2 illustrates a block diagram of a control housing 120 according to some embodiments;

FIG. 3A illustrates a side view of a shelf assembly 130 according to some embodiments;

FIG. 3B illustrates a block diagram of a table-top assembly according to some embodiments;

FIG. 4 illustrates a mobile communication device configured to engage in bidirectional communications with a charging and protection stand according to some embodiments;

FIG. 5A illustrates a side view of a mobile communication device charging and protection stand or table according to some embodiments;

FIG. 5B illustrates a front view of the mobile communication device charging and protection stand or table according to some embodiments;

FIG. 5C illustrates a perspective top view of the mobile communication device charging and protection stand or table according to some embodiments;

FIG. 5D illustrates a top view of the mobile communication device charging and protection stand or table according to some embodiments;

FIG. 6A illustrates a side view of a sun table power apparatus according to some embodiments;

FIG. 6B illustrates the components or portions of the sun table apparatus illustrated in FIG. 6A;

FIG. 7A illustrates a side view of a free-standing sun table power charging apparatus including a one-sided shelf assembly according to some embodiments;

FIG. 7B illustrates a front view of a free-standing sun table power charging apparatus including a one-sided shelf assembly according to some embodiments;

FIG. 7C illustrates a top view of a free-standing sun table power charging apparatus including a one-sided shelf assembly according to some embodiments;

FIG. 8A illustrates a front view of a sun table charging apparatus to be utilized in loose ground environments such as sand according to some embodiments;

FIG. 8B illustrates a side view of a sun table charging apparatus to be utilized in loose ground environments such as sand according to some embodiments;

FIG. 9A illustrates a parasol with an attachable or connectable solar shelf according to some embodiments;

FIG. 9B illustrates a top view of a solar shelf or sun table according to some embodiments;

FIG. 9C illustrates a cut away side view of the attachable or connectable solar shelf according to some embodiments; and

FIG. 9D illustrates a side view of a top section and a bottom section of the attachable or connectable solar shelf according to embodiments.

### DETAILED DESCRIPTION

The foregoing, and other features and advantages of the claimed subject matter, will be apparent from the following, more particular description of the preferred embodiments of the claimed subject matter, the accompanying drawings, and the claims.

In the following detailed description, numerous specific details are set forth to provide a thorough understanding of claimed subject matter. For purposes of explanation, specific numbers, systems and/or configurations are set forth, for example. However, it should be apparent to one skilled in the relevant art having benefit of this disclosure that claimed subject matter may be practiced without specific details. In other instances, well-known features may be omitted and/or simplified so as not to obscure claimed subject matter. While certain features have been illustrated and/or described herein, many modifications, substitutions, changes and/or equivalents may occur to those skilled in the art. It is, therefore, to be understood that appended claims are intended to cover any and all modifications and/or changes as fall within claimed subject matter.

References throughout this specification to one implementation, an implementation, one embodiment, embodiments, an embodiment and/or the like means that a particular feature, structure, and/or characteristic described in connection with a particular implementation and/or embodiment is included in at least one implementation and/or embodiment of claimed subject matter. Thus, appearances of such phrases, for example, in various places throughout this specification are not necessarily intended to refer to the same implementation or to any one particular implementation described. Furthermore, it is to be understood that particular features, structures, and/or characteristics described are capable of being combined in various ways in one or more implementations and, therefore, are within intended claim scope, for example. In general, of course, these and other issues vary with context. Therefore, particular context of description and/or usage provides helpful guidance regarding inferences to be drawn.

Likewise, in this context, the terms “coupled”, “connected,” and/or similar terms are used generically. It should be understood that these terms are not intended as synonyms. Rather, “connected” is used generically to indicate that two or more components, for example, are in direct physical, including electrical, contact; while, “coupled” is used generically to mean that two or more components are potentially in direct physical, including electrical, contact; however, “coupled” is also used generically to also mean that two or more components are not necessarily in direct contact, but nonetheless are able to co-operate and/or interact. The term “coupled” is also understood generically to mean indirectly connected, for example, in an appropriate context.

The terms, “and”, “or”, “and/or” and/or similar terms, as used herein, include a variety of meanings that also are expected to depend at least in part upon the particular context in which such terms are used. Typically, “or” if used to associate a list, such as A, B or C, is intended to mean A, B, and C, here used in the inclusive sense, as well as A, B or C, here used in the exclusive sense. In addition, the term “one or more” and/or similar terms is used to describe any feature, structure, and/or characteristic in the singular and/or is also used to describe a plurality and/or some other combination of features, structures and/or characteristics.

Likewise, the term “based on,” “based, at least in part on,” and/or similar terms (e.g., based at least in part on) are understood as not necessarily intending to convey an exclusive set of factors, but to allow for existence of additional factors not necessarily expressly described. Of course, for all of the foregoing, particular context of description and/or usage provides helpful guidance regarding inferences to be drawn. It should be noted that the following description merely provides one or more illustrative examples and claimed subject matter is not limited to these one or more illustrative examples; however, again, particular context of description and/or usage provides helpful guidance regarding inferences to be drawn.

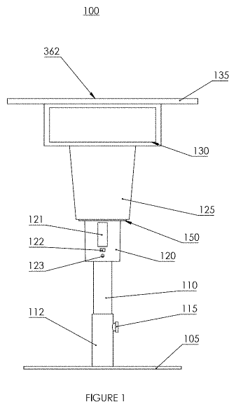

FIG. 1 illustrates a mobile communication device charging and protection stand or table according to some embodiments. In some embodiments, the mobile charging and protecting stand or table 100 may comprise a base or base assembly 105, an adjustable support assembly or center support assembly 110, an adjustment assembly 115, an control or electronics housing 120, a speaker or sound housing 125, a shelf assembly 130 and/or a tabletop assembly or table assembly 135. In some embodiments, the charging and protecting stand 100 may have an adjustable height. In some embodiments, the charging and protecting stand may range in 15 inches to 40 inches in height. In some embodiments, the base 105 and the tabletop assembly 135 may have a width of 20 inches to 40 inches. In embodiments, the tabletop assembly 135 may be referred to as the table assembly 135.

In some embodiments, an operator may utilize an adjustment assembly 115 (e.g., a knob, a switch, or other similar device) to adjust a height of the charging and protecting stand or table 100. In some embodiments, the base assembly 105 may have a top portion that is hollow or open and thus a portion of the length of the adjustable support assembly 110 may rest or be positioned within the top portion of base assembly 105 depending on the adjusted height. In some embodiments, the base assembly 105 may be circular in shape although other shapes may be utilized. In some embodiments, the top portion of the base assembly 105 may be circular and may include an opening or hollow space into which the adjustable support assembly 110 may be positioned and/or inserted. In some embodiments, the base assembly 105 may be made of a heavy material in order to provide stability to the charging and protecting stand or table 100. In come embodiments, the adjustable support assembly may be coupled, connected and/or attached to the base assembly 105 and/or the control housing 120. In some embodiments, the adjustable support assembly 110 may be a tube and/or a shaft. In some embodiments, the adjustable support assembly 110 may be a metal, a plastic, a combination of both and/or a composite material. In some embodiments, the adjustable support assembly 110 may be a housing and/or a tube or shaft. In some embodiments, the adjustable support assembly 110 may have a circular shape. In some embodiments, there may be no adjustable support assembly and the base assembly may comprise a circular flat portion and a small diameter tube assembly 112 that rises from the circular flat portion.

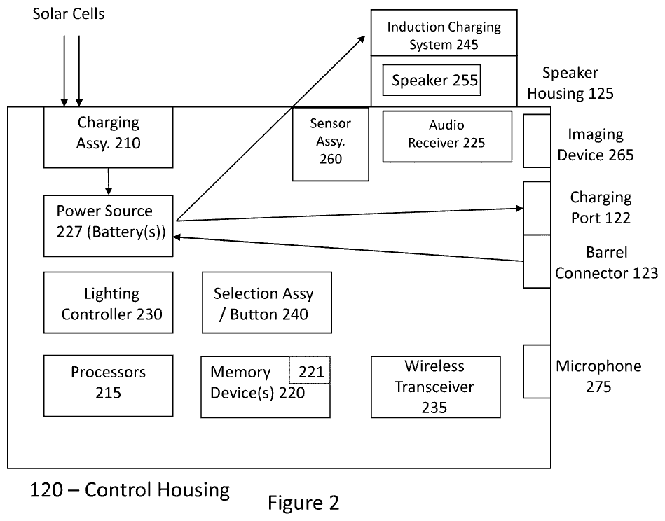

In some embodiments, the control housing 120 may comprise a plurality of buttons or selection assemblies 121, an universal serial bus (USB) or mobile communication device charger 122 to provide power and/or charging for mobile communication devices, and/or a barrel charging assembly port 123 to receive power from an external source such as a wall outlet and/or a generator. FIG. 2 illustrates a block diagram of a control housing 120 according to some embodiments. In some embodiments, the control housing 120 may comprise a charging assembly 210, one or more processors 215, one or more memory devices 220, and/or computer-readable instructions 221 stored in the one or more memory devices 220 and/or executable by the one or more one or more processors 215 to perform control housing and mobile phone charging and protection table or stand operations. In some embodiments, the control housing 120 may comprise one or more audio receivers 225 and/or one or more wireless communication transceivers 235. In some embodiments, the control housing 120 may comprise one or more microphones 275, one or more imaging devices 265, and one or more sensor assemblies 260. In some embodiments, the control housing 120 may comprise one or more lighting controllers 230, a plurality of selection assemblies (e.g., manual buttons) 240 and/or one or more induction control circuit assemblies 245. While FIG. 2 illustrates that these components and/or assemblies may be located in the control housing 120, some of the components may be located in other assemblies (e.g., the speaker housing 125, the shelf assembly 130 and/or the tabletop assembly 135 (or even the base assembly 105). The specification should not be read to limit the locations of these components and assemblies to only the control housing although one embodiment may clearly include all the shown components and assemblies in the control housing 120. In some embodiments, as an example, the one or more audio receivers 225 may be located in the speaker housing 125 and not in the control housing 120.

In some embodiments, the control housing 120 may be circular, trapezoidal, or rectangular in shape with an opening or hole in its center to allow the support assembly 110 to pass through an inner portion of the control housing 120. In some embodiments, the support assembly 110 may be coupled, connected and/or attached to a surface of the inner portion of the control housing 120. In other words, the control housing 120 may have a hollow center in which the support assembly 110 is positioned. In some embodiments, a tube or shaft extending from the support assembly 110 may extend and may be positioned in the opening and/or hollow center of the control housing 120. In some embodiments, the control housing 120 may be made of a plastic, a composite and/or a metal material. In some embodiments, the control housing 120 may be made utilizing additive materials and/or 3D printing techniques.

In some embodiments, the one or more solar panels or solar cell assemblies may be coupled and/or connected to the one or more charging assemblies 210 and/or the one or more charging assemblies may supply power (e.g., voltage and/or current) to a rechargeable power source 227 (e.g., one or more rechargeable batteries). In some embodiments, the rechargeable power source 227 may provide power to other assemblies and/or components of the control housing 120 and/or the rest of the mobile device charging and protection table or stand 100. In some embodiments, the rechargeable power source 227 may provide power to a universal serial bus (USB) port or interface 122 in order to allow users and/or operators to charge mobile phones (mobile communication devices) or tablets by connecting a cable or adapter to the USB port/interface 122. In some embodiments, the rechargeable power source 227 may receive power not only from the solar panel or cells, but also may receive power from an external power source (e.g., generator or AC outlet) via a barrel connector 123.

In some embodiments, the control housing 120 may comprise a plurality of selection assemblies or buttons 121 that are on an outside surface of the control housing 120. In some embodiments, a plurality of selection assemblies or buttons 121 may comprise an on/off button, a wireless communication activation button, a lighting assembly activation button, a solar panel activation button, a voice command activation button (e.g., voice recognition) and/or an audio system activation button. In some embodiments, the selection assemblies or buttons 121 may interface with the associated and/or corresponding assembly or component, either directly and/or indirectly through the computer-readable instructions executable by the one or more processors. In some embodiments, the selection assemblies or buttons 121 may also alone, or in combination, be utilized to establish a password process, to initiate and/or execute a shutdown process, and/or to be utilized to establish customized settings for the one or more lighting assemblies 150 and/or speaker assemblies 255. In some embodiments, the control housing 120 may comprise one or more lighting assemblies 150 to shine or project light to an area around the mobile communication device charging and protection stand or table 100.

In some embodiments, the control housing 120 or the speaker housing 125 may comprise one or more lighting controllers 230 and/or one or more lighting assemblies 150. In some embodiments, computer-readable instructions executable by the one or more processors 215 may communicate with the one or more lighting controllers 230 to interface with the one or more lighting assemblies 150. In some embodiments, the computer-readable instructions executable by the one or more processors may communicate the following parameters and/or information through the one or more lighting controllers 230 to the one or more lighting elements and/or assemblies: 1) activation and/or deactivation times of the one or more lighting elements or assemblies 150; 2) intensity of the one or more lighting elements or assemblies 150; 3) patterns and/or sequencing of the one or more lighting elements or assemblies 150; and/or 4) colors projected of the one or more lighting elements or assemblies 150. In some embodiments, if the control housing 120 includes the one or more lighting assemblies 150 on a side outside surface of the control housing, the lighting assemblies may project light outwards from the control housing 120 and light up the environment around the mobile communication device charging and protection stand or table 100 according to some embodiments. In some embodiments, the one or more lighting element or assemblies 150 may be positioned or located on a bottom surface or portion of the speaker assembly 125 and thus may be directing light or light rays in a slightly downward direction and sideways direction from the speaker assembly 125.

In some embodiments, the control housing 120 or the speaker assembly 125 may comprise one or more wireless communication transceivers 235. In some embodiments, the one or more wireless communication transceivers 235 may be a low-energy personal area network (PAN) transceiver (e.g., a BLE transceiver or similar transceivers), a PAN transceiver (e.g., a Bluetooth or Zigbee transceiver), a wireless LAN, WiFi or IEEE 802.11 compatible wireless communication transceiver, and/or a cellular wireless communication transceiver (e.g., a 3G, 4G, or 5G cellular transceiver). In some embodiments, the one or more wireless communication transceivers 235 may receive operational commands from a mobile communication device and/or other computing devices via the one or more wireless communication transceivers 235. For example, these operational commands may be 1) turning on or off the lighting assemblies 230; 2) turning on or off the audio amplifier and/or speakers 225; 3) playing audio files via the one or more speaker assemblies 125; 4) turn on or off the one or more inductive charging assemblies 245; and/or 5) turning on or off the one or more charging assemblies 210 and/or the one or more solar panels. In some embodiments, the operational commands may be for other components and/or assemblies.

In some embodiments, the control housing 120 or the speaker housing 125 may comprise one or more audio receivers or amplifiers 225. In some embodiments, computer-readable instructions 221 executable by the one or more processors 215 of the mobile communication device charging and protection stand or table 100 may retrieve music and/or sound files from the one or more memory devices 220 and communicate the music and/or sound files to the one or more audio receivers or amplifiers 225 and then to one or more speaker assemblies 255. In some embodiments, the one or more speaker housings 125 may comprise one or more speaker assemblies 255 to reproduce and/or play transferred music and/or sound files. In some embodiments, there may be one or more speaker housings 125 or there may be one speaker housing 125. For simplicity, the specification may refer to one speaker housing 125. In some embodiments, the speaker housing 125 may further comprise one or more sound radiators, one or more amplifiers, and/or one or more subwoofers in order to enhance certain aspects of the reproduction and/or playing of the music and/or sound files. In some embodiments, rather than internally storing the music and/or sound files in the one or memory devices of the mobile communication device charging and protection stand or table 100, one or more wireless communication transceivers 235 may receive the music and/or sound files and may transfer the sound or music files to the one or more audio receivers or amplifiers 225. In some embodiments, a mobile communication device (e.g., a smartphone and/or tablet or a wearable computing device or other computing devices) may transfer the music and/or sound files to the one or more wireless communication transceivers 235 of the charging and protection stand or table 100. In some embodiments, the one or more wireless communication transceivers 235 may be a Bluetooth Low Energy (BLE) wireless communication transceiver in order to utilize less power. In other embodiments, the one or more wireless communication transceivers 235 may be a personal area network (PAN) transceiver (e.g., a Bluetooth transceiver), a WiFi or 802.11 wireless transceiver and/or a cellular communications transceiver (e.g., 3G, 4G or 5G). In some embodiments, streaming services (e.g., remote server computing devices and/or cloud-based server computing devices) may communicate the music and/or sound files to the mobile communication device charging and protection stand 100 via the one or more wireless communication transceivers 235. In some embodiments, transfer of music and/or sound files from a remote server computing device and/or cloud-based server may require a more robust and/or higher bandwidth communication channel and thus may utilize one or more wireless LAN, Wi or 802.11 wireless communication transceivers and/or cellular communication transceivers.

In some embodiments, the control housing 120, the speaker housing 125, the shelf assembly 130 and/or the table-top assembly may comprise one or more sensor assemblies 260. In some embodiments, the sensor assemblies 260 may comprise environmental sensor assemblies, directional sensor assemblies, and/or proximity sensor assemblies. In some embodiments, the environmental sensor assemblies may be wind sensor assemblies, humidity sensor assemblies, temperature sensor assemblies, ultraviolet UVa and UVB sensor assemblies, light sensor assemblies, air quality sensors (e.g., smoke sensors, methane sensors, carbon dioxide sensors, smog sensor assemblies, particulate matter sensor assemblies, volatile organize compounds (VOC) density sensor assembles, dust sensor assemblies) and/or lightning sensor assemblies. In some embodiments, the one or more sensor assemblies 260 in the mobile communication device charging and protection stand or table may be able to capture measurements and/or parameters of the environment around the charging and protection stand or table 100. In some embodiments, computer-readable instructions 221 executable by the one or more processors 215 may store the captured measurements and/or parameters (in one or more memory devices 220) of the one or more sensor assemblies 260 and/or communicate the captured measurements and/or parameters to an external computing device (e.g., like a mobile communication device) via one or more wireless communication transceivers 235. In some embodiments, the one or more sensor assemblies 260 may be proximity sensors. In some embodiments, the one or more proximity sensors may be motion detectors, line of sight detectors, proximity detectors or other detectors or sensors identifying whether movement is occurring around the mobile communication device charging and protection stand or table 100. In some embodiments, computer-readable instructions executable by the one or more processors 215 in the charging and protection stand or table may receive a signal, command and/or message from one or more proximity sensors identifying that there is motion in the area around the stand or table. In response, computer-readable instructions 221 executable by the one or more processors 215 may communicate commands, messages and/or signals to components or assemblies of the charging and protection stand or table 100 to alert that motion has been detected (e.g., commands, messages or signals may be communicated to one or more lighting systems 150 to emit a specific pattern or may be communicated to audio systems 225 and/or speakers 255 to audibly alert that motion has been detected. In response to detection of motion, computer-readable instructions 221 executable by the one or more processors 215 may communicate commands, messages and/or signals to an external computing device (e.g., such as a mobile computing device) to identify that motion has been detected around the mobile communication device charging and protection stand or table and to prompt a user of the mobile communication device to decide whether or not to take action. In some embodiments, the one or more sensor assemblies 260 may be directional sensors. In some embodiments, the directional sensors may be digital compasses, GPS transceivers, magnetometers, barometers, accelerometers and/or gyroscopes. In some embodiments, the directional sensors may capture direction measurements and/or other parameters related to the charging and protection table and/or stand 100. In some embodiments, computer-readable instructions 221 may be executable by one or more processors 215 of the stand or table 100 to receive the captured direction measurements and/or other parameters and to store the captured direction measurements and/or other parameters in one or more memory devices 220. In some embodiments, computer-readable instructions 221 may be executable by one or more processors 215 of the stand or table 100 to communicate the captured direction measurements and/or other parameters (of the directional sensors) to an external computing device such as a mobile communication device.

In some embodiments, the control housing 120, the speaker housing 125, the shelf assembly 130 and/or the table-top assembly may comprise one or more imaging devices 270. In some embodiments, the one or more imaging devices 270 may capture images and/or video from an area around the mobile communication device charging and protection stand or table 100. In some embodiments, computer-readable instructions 221 executable by the one or more processors 215 may store the captured or obtained video and/or images in one or more memory devices 220 from the one or more imaging devices 270 and/or may communicate the captured or obtained video and/or images to an external computing device (e.g., like a mobile communication device) via one or more wireless communication transceivers 235.

In some embodiments, the control housing 120, the speaker housing 125, the shelf assembly 130 and/or the table-top assembly 135 may comprise one or more microphones 275. In some embodiments, the one or more microphones 275 may capture sounds, audio and/or voice commands spoken by users or operators in an area around the charging and protection stand or table 100. In some embodiments, the sounds or audio may be stored in one or more memory devices 220 and/or communicated to an external computing device via one or more wireless communication transceivers 235. In some embodiments, computer-readable instructions 221 may be executable by one or more processors 215 to analyze the voice commands and determine what actions the charging and protection stand or table 100, as will be described in detail below.

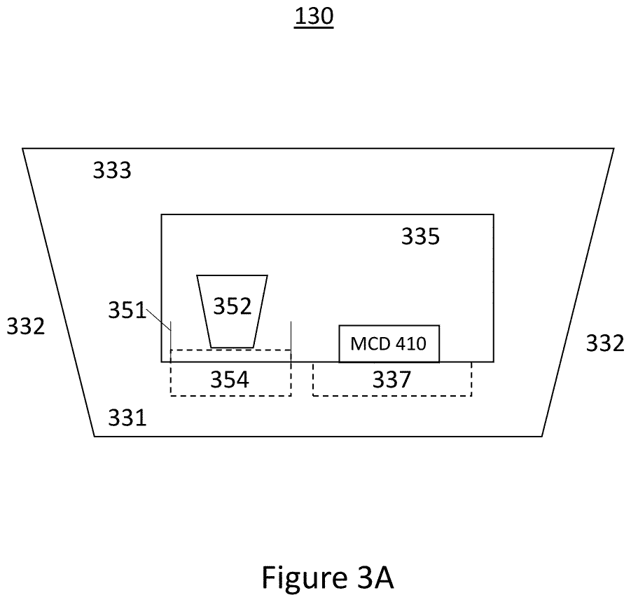

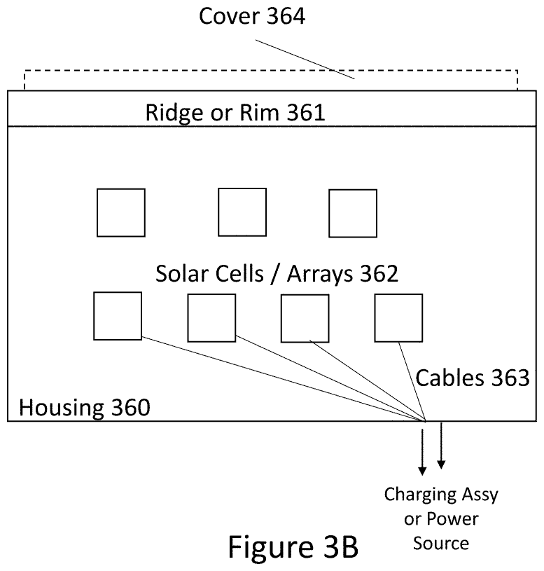

In some embodiments, the mobile communication device charging and protection stand 100 may comprise a shelf assembly 130. FIG. 3A illustrates a side view of a shelf assembly 130 according to some embodiments. In some embodiments, a shelf assembly 130 may comprise a bottom section or subassembly 331, two side sections or subassemblies 332 and/or a top section or subassembly 333. In some embodiments, the shelf assembly 130 may comprise a hollow area or opening 335 in between the bottom section or subassembly 331, two side sections or subassemblies 332, and the top section or subassembly 333. In some embodiments, the bottom section may have a surface (which may be referred to as a bottom surface) on which electronic devices (e.g., mobile communication devices) may rest. In some embodiments, these mobile communication devices may be cellular phones, smart phones, tablets, chargeable and/or wireless earphones or earbuds, or other similar devices. In some embodiments, the shelf assembly 130 may comprise charging circuity 337 (e.g., a power source coupled to cables or wires further coupled with induction coils) which may be referred to as induction charging assemblies. In some embodiments, the power source may generate voltage and/or current (e.g., power) which may be transferred to the induction coils in order to produce a magnetic field and allow a mobile communication device to powered by placing the mobile communication on top of the induction coils. In some embodiments, the charging circuity 337 may be embedded and/or integrated into a top surface of a bottom section or subassembly 331 of the shelf assembly. In some embodiments, the charging circuitry 337 may power and/or charge a mobile communication device placed on top of or near the charging circuitry 337. In some embodiments, the top section or subassembly 333 of the shelf assembly 130 may protect one or more mobile communication devices placed on the top surface of the bottom section or subassembly 331 from outside elements (e.g., sunlight, rain and/or other environmental conditions). In some embodiments, the top section or subassembly 333 may have the same dimensions (length and width) as the bottom section or subassembly 331 in order to provide maximum protection for any mobile communication devices placed on a top surface of the bottom section or subassembly 331 of the mobile communication device protection and charging table or stand 100. This is a significant advantage over any other charging tables in that prior art tables may allow mobile communication devices to be charged, but do not provide any protection from environmental elements. In some embodiments, other tables may also include an awning and/or an umbrella canopy or frame in order to provide protection from environmental conditions and/or elements. However, these are placed a distance away from the user and/or the phone and may not provide adequate protection from the elements. This mobile communication device charging and protection apparatus described herein provides charging and/or protection while also being outdoors. The protection allows mobile communication devices to be charged and not be subjected to overheating.

In some embodiments, the shelf assembly 130 may also comprise a drink or liquid holder assembly 350. In some embodiments, the drink or liquid holder assembly 350 may have circular or semi-circular raised portions 351 off the top surface of the bottom section or assembly 331 to allow a drink or cup to be placed on the top surface and not fall down. In some embodiments, the drink or liquid holder assembly 350 may be placed or positioned in a recessed or sunken area of a top surface of the bottom section or assembly 331. In some embodiments, the drink or liquid holder assembly 350 may also be able to cool or heat a liquid by the utilizing of a conductive cup 352 and/or a thermal device or circuitry 354. In some embodiments, the power source 227 may provide power to a thermal device or circuitry 354. In some embodiments, the power source may provide power to thermal device or circuitry 354 in order to heat up or cool down the liquid in the conductive cup 352. In some embodiments, the top section or subassembly 333 may protect any drinks positioned on placed on the bottom section or subassembly 332 from any outside elements, such as sunlight, rain and/or other environmental conditions. This is another advantage of this table over other prior table designs.

In some embodiments, the mobile communication device charging and protection stand or table 100 may comprise a table-top assembly 135. FIG. 3B illustrates a block diagram of a table-top assembly according to some embodiments. In some embodiments, a table-top assembly 135 may be placed on a top surface of a top section or subassembly 333 of the shelf assembly 130. In some embodiments, a table-top assembly may comprise an oval, circular or square shaped housing 360 with a rim 361 running around a circumference of the oval, circular or square shaped housing 360, one or more solar cells, cell arrays or panels 362 and/or wires or cables 363. In some embodiments, the wires or cables 363 may couple the one or more solar cells, cell arrays or panels 362 to the charging assembly and/or power source of the mobile communication device charging and protection stand or table 100. In some embodiments, in order to protect the one or more solar cells, cell arrays or panels 362 from the element, the table-top assembly 135 may comprise a top cover 364 to cover the one or more solar cells, cell arrays or panels 362. In some embodiments, in order to allow to one or more solar cells, cell arrays or panels 362 to convert sun energy to the electric power, the top cover 364 of the table-top assembly 135 may be transparent and/or see through plastic or a similar transparent material. In other cases, the top cover may be more opaque in order to block out the sun from the one or more solar cells, or solar cell arrays and keep them from overheating. In some embodiments, the table-top assembly 135 may be made of a plastic material, a metal material, a wood material, a composite material and/or any combination thereof. In some embodiments, the table-top assembly 135 may further comprise one or more sensor assemblies 260 (e.g., environmental sensors, directional sensors, and/or proximity sensors) as described above. In some embodiments, the table-top assembly 135 may further comprise one or more microphones 275, the one or more microphones utilized to capture voice commands by users and/or operators of the mobile communication device charging and protection stand or table 100. The operation of the one or more microphones is described above. In some embodiments, the table-top assembly 135 may further comprise one or more imaging devices 265, the operation of which i described above. In some embodiments, the table-top assembly 135 may not include a ridge or rim. In some embodiments, the table-top assembly 135 may comprise a recessed area in its center where the one or more solar cells or solar cells arrays 362 may be located and/or positioned.

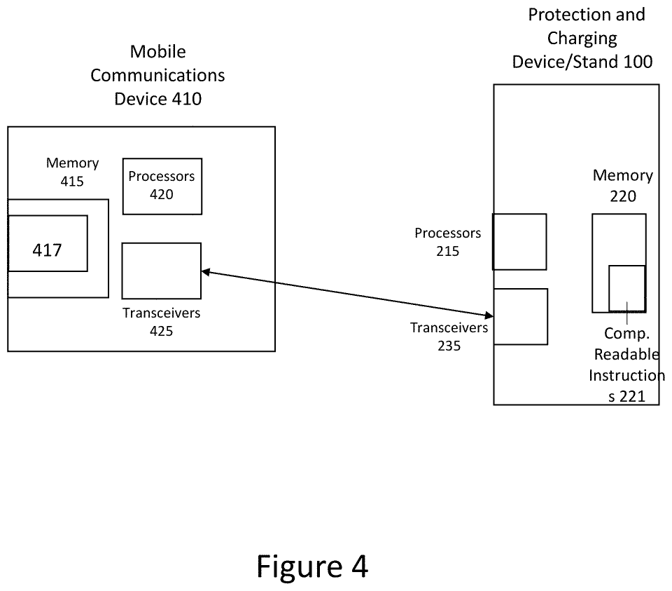

FIG. 4 illustrates a mobile communication device configured to engage in bidirectional communications with a charging and protection stand according to some embodiments. In some embodiments, a mobile communication or computing device 410 may communicate with the charging and protection stand 100 in order to control operations of components, assemblies and/or devices (e.g., lighting assemblies, wireless communication transceivers, speakers and/or audio receivers, solar cells or solar cell assemblies and charging assemblies), receive status parameters for components, assemblies and/or devices, and/or receive sensor measurements or parameters. In embodiments, a mobile communication device 410 may be communicating bi-directionally with the charging and protection stand 100. This is a significant improvement over communicating via a remote control device where only limited commands such as on or off may be communicated to tables and there is no receiving of parameters and/or measurements back from a table. The charging and protection stand or table 100 described herein may be controlled by a software application running on a mobile computing device 410 and may communicate measurements, parameters, information and/or audio back to the mobile communications device 410. In some embodiments, for example, a mobile communication device 410 may comprise one or more processors 420, one or more memory devices 415, one or more wireless communication transceivers 425 and/or computer-readable instructions 417 stored in the one or more memory devices 415. In some embodiments, the computer-readable instructions 417 stored in the one or more memory devices 415 may include charging and protection stand software (e.g., interface or control software for communicating and receiving communications from the charging and protection stand or assembly or table 100). In some embodiments, the computer-readable instructions 417 may be executable by the one or more processors 420 to communicate and/or interface with the charging and protection stand or assembly 100 In some embodiments, for example, the software 417 executable by one or more processors 420 of a mobile computing device 410) may communicate commands, messages and/or instructions to a charging and protection stand or assembly 100 via one or more wireless communication transceivers 425 to turn on and off the charging and protection stand or assembly or table, to turn on lighting assemblies, to engage and/or activate solar cells and/or solar arrays and/or charging assemblies, to turn on charging and protection stand wireless communication transceivers, to transfer audio files, to turn on or off or put into a power-saving move a power source, to engage and/or activate selection assemblies and/or buttons, to turn on or off sensor assemblies, to communicate with induction charging systems and/or to communicate and/or activate audio receivers and/or speakers, as well as other features describe herein.

In some embodiments, the communications may be received via one or more wireless communication transceivers 235 in the charging and protection stand or assembly 100. In embodiments, the software 417 (e.g., computer-readable instructions) in the mobile computing device 410 may receive operational parameters and/or confirmation back that the operation has been completed and the utilized components, devices, and/or assemblies (e.g., lighting assemblies or sensor assemblies) are operational via the one or more wireless communications transceivers 425 in the mobile computing device 410. In some embodiments, as another example, a mobile communication device 410 may communicate a command to activate a temperature sensor (or other sensor in the charging and protection stand or assembly 100) and to capture temperature sensors (or other sensor) readings or measurements. In some embodiments, charging and protection stand or assembly or table 100 may communicate and/or transmit back captured temperature sensor measurements (or other sensor measurements) to the mobile communication device 410 utilizing the one or more wireless communication transceivers 235 in the automation attachment and the one or more wireless communication transceivers 425 in the mobile computing device 410. In some embodiments, the components or assemblies of the charging and protection stand or assembly 100 that may be bidirectionally communicated with by the mobile computing device 272 may include one or more environmental sensors, one or more directional sensors, one or more imaging devices, one or more audio receivers and/or speakers, one or more voice recognition engines, one or more lighting elements or lighting assemblies, one or more microphones, one or more battery assemblies, one or more charging assemblies, one or more wireless communication transceivers and/or one or more solar panels or solar cells. In some embodiments, a mobile communication or computing device 410 may utilize software installed thereon to communicate with the charging and protection stand or assembly 100 (e.g., SMARTSHADE SOFTWARE) and receive input via a touchscreen, a keyboard, a stylus or other user interface input components. In some embodiments, a user or operator may speak audio commands into a mobile computing device 410 to control operation of the charging and protection stand or assembly 100 (“Turn on Cellular Wireless Transceivers, Turn on Solar Cell Assemblies, Turn on Speakers or Audio System, Turn on or off lights, Capture Sensor Measurements”). These are representative commands and other voice commands may be utilized to interact, control and/or interface with the charging and protection stand or assembly 100.

In some embodiments, the computer-readable instructions 417 executable by the one or more processors 420 of the mobile computing device 410 may include voice recognition software in addition to the protection and charging device/stand/assembly software. In some embodiments, the voice recognition software executing on the one or more processors 420 of the mobile computing device 410 may recognize, interpret and generate protection and charging table/stand-specific commands and the mobile computing device 410 may communicate the generated protection and charging table/stand-specific commands to the protection and charging table/stand via wireless communication transceiver 425 and wireless communication transceiver 235 (e.g., in the charging and protection stand or assembly or table) to control operations of assemblies and/or components in the protection and charging device/stand 100 (e.g., audio systems, solar panels and charging assemblies, sensors, lights, etc.). In some embodiments, the voice commands may be communicated as audio files to the protection and charging device/stand/table 210, (via the wireless communication transceivers 425 and 235) and computer-readable instructions executable by one or more processors 215 in the protection and charging device/stand 100, which may either analyze, recognize and then generate protection and charging table/stand-specific commands locally (e.g., within the charging and protection stand or assembly or table 100) or may communicate the received audio files (or text representative thereof) to a third party computing device (a voice recognition server, such as Alexa servers, located locally or remotely) for analyzation, interpretation and generation of protection and charging tabe/stand-specific commands, which are then communicated back to the charging and protection stand or assembly or table 100 in order to have the recognized operations performed via one or more wireless or wired communication transceivers 235.

In some embodiments, the mobile communications device 410 may be a smartphone, a tablet, a laptop computer, a network computer, a mobile phone, etc.). Although the discussions above have focused on a mobile computing device, the discussions apply to desktop computers, administrative computing devices, point-of-sale computing devices and/or home security computing devices, all of which can have charging and protection stand or assembly interface software installed thereon and executable by processors to interface with and/or control an charging and protection stand or assembly 100 that the desktop computing device, administration computing device, POS computing device and/or home security device are communicatively coupled with (e.g., via wireless or wired communication transceivers).

In some embodiments, a mobile communications device 410, a computing device at a remote location, or an existing computing device (e.g., a POS terminal at a hospitality venue) may communicate with and receive communications from a plurality of charging and protection stand or assemblies 100 utilizing wireless or wired communication transceivers. In some embodiments, for example, this means a facility or event venue may have multiple charging and protection stand or assemblies and be able to control the operation of multiple charging and protection stand or assembly 100. This provides an advantage and/or improvement over existing systems because there is the ability to automate a number of charging and protection stands or assemblies or tables 100 In some embodiments, the mobile computing device 410 (or computing device at a remote location or existing computing device at hospitality venue) may bidirectionally communicate with two or more charging and protection stand or assemblies 100 via the one or more wireless communication transceivers 235 in a single charging and protection stand or assembly 100 or via the one or more wireless communication transceivers 235 in both charging and protection stand and/or assemblies or tables. In some embodiments, the components, assemblies or devices (e.g., environmental sensor assemblies; audio systems and speakers, solar cells or panels and/or charging assemblies, and/or lighting assemblies, and/or one or more image devices) may communicate sensor measurements and values; audio, video, images; and/or status parameters of components, assemblies or devices back to the mobile computing device 410 via the one or more wireless computing devices (or computing device at a remote location or existing computing device at hospitality venue). In some embodiments, the measurements and/or status parameters (e.g., and/or audio, video or images) may be displayed within application software executing on the mobile computing device 410 (or remote computing devices describe above) after being received via the one or more wireless communication transceivers (e.g., such as the wireless communication transceiver(s) 425 of the mobile computing device 410). In embodiments, the operation of the multiple charging and protection stand or assemblies 100 may be controlled via fleet management software such as has been described in application Ser. No. 16/008,000, filed Jun. 13, 2018, and entitled METHOD AND SYSTEM OF FLEET MANAGEMENT OF SHADING DEVICES, which is incorporated herein by reference. In embodiments, voice control, gesture recognition and/or utilization of menu icons may be utilized to control operation of one or more multiple charging and protection stand or assemblies 100 through the application software described herein.

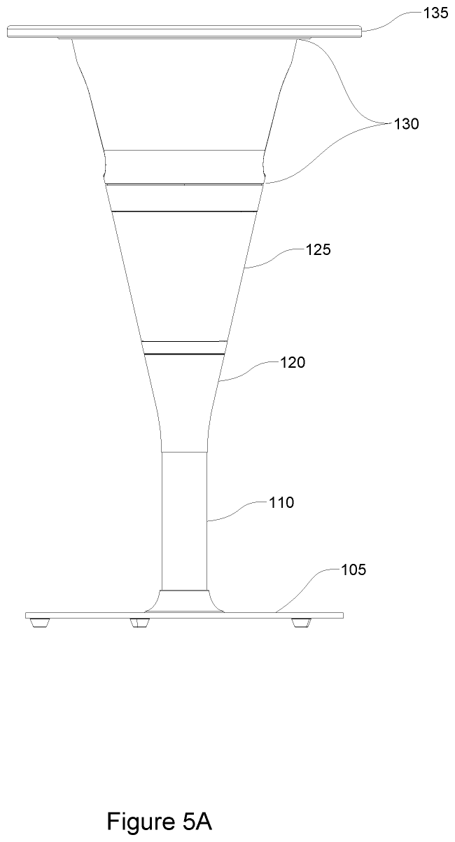

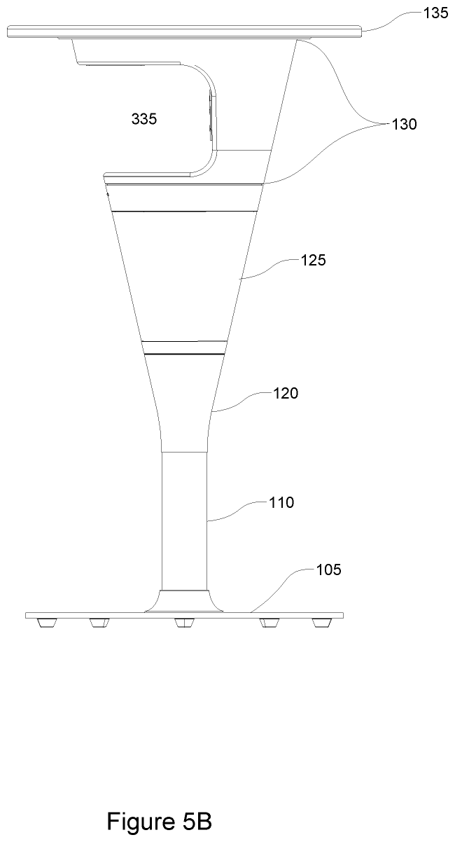

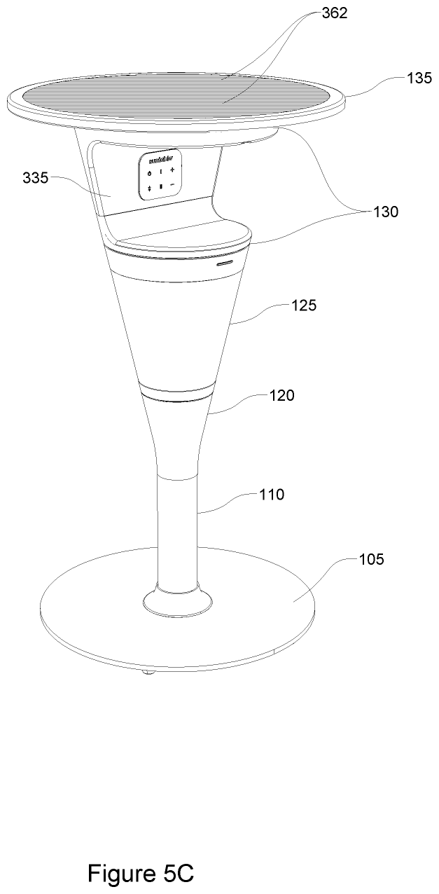

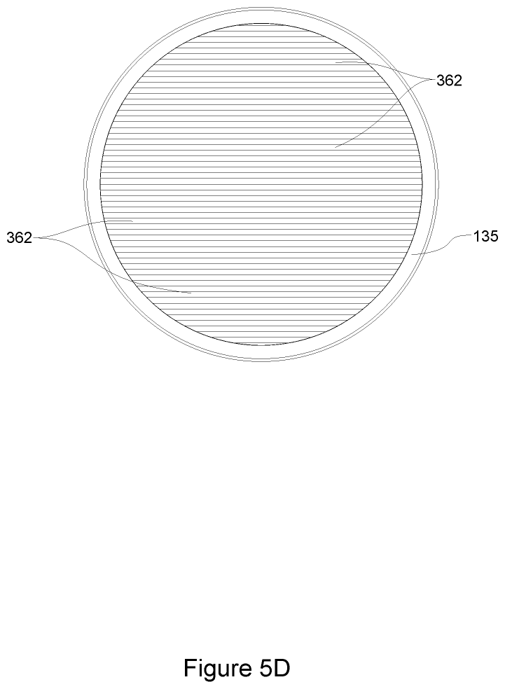

FIG. 5A illustrates a side view of a mobile communication device charging and protection stand or table according to some embodiments. FIG. 5B illustrates a front view of the mobile communication device charging and protection stand or table according to some embodiments. FIG. 5C illustrates a perspective top view of the mobile communication device charging and protection stand or table according to some embodiments. FIG. 5D illustrates a top view of the mobile communication device charging and protection stand or table according to some embodiments. These figures show a prototype model of a mobile communication device charging or protection table or stand according to embodiments. In some embodiments, the mobile communication device charging and protection table or stand may include a base assembly 105, a central support assembly 110, a control housing or assembly 120, a speaker housing 125, a shelf assembly 130 and/or a table-top assembly 135. In some embodiments, the central support assembly 110 may also include the control housing or assembly 120. In some embodiments, the central support assembly may be connected and/or coupled to the base assembly 105 and/or the speaker housing 125. In some embodiments, if the central support assembly 110 and the control housing or assembly 120 are separate assemblies, and therefore the control housing or assembly 120 may be connected and/or coupled to the central support assembly 110 and/or the speaker housing 125. In some embodiments, the speaker housing 125 may be coupled and/or connected to the shelf assembly 130. In some embodiments, the table-top assembly 135 may be connected and/or coupled to the shelf assembly 130.

In some embodiments, the components and/or assemblies shown in FIGS. 2, 3A or 3B (and discussed above) may also be included in the mobile communication device charging and protection stand or table. FIGS. 5C and 5D illustrate the one or more solar cells or cell arrays 362 according to some embodiments. In some embodiments, as shown in FIG. 5D, the one or more solar cells or cell arrays 362 may be in a center portion of the table-top assembly 135. In some embodiments, as shown in FIG. 5D the one or more solar cells or cell arrays 362 may be arranged in a circular pattern. In some embodiments, a table-top assembly 135 may have a recessed portion into which the one or more solar cells or cell arrays 362 are placed, attached and/or connected. FIG. 5B clearly illustrates the opening and/or hollow portion 335 of the shelf assembly 130 according to some embodiments. This is a significant feature of the mobile communication device charging and protection stand or table 500. This is where the charging of the mobile communication device may occur while at the same time providing shade to the mobile communication device. Other tables either do not provide shade or provide shade via a umbrella canopy or shading apparatus.

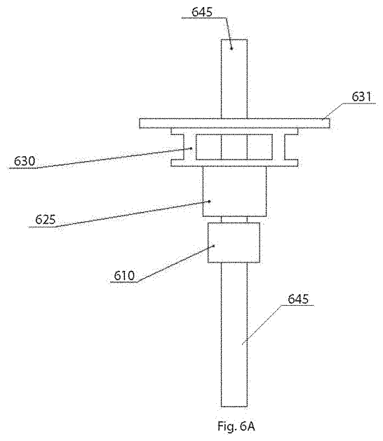

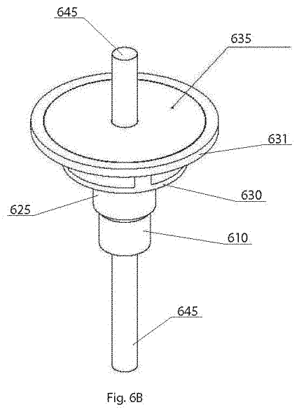

FIG. 6A illustrates a side view of a sun table power apparatus according to some embodiments. In some embodiments, the sun table apparatus or device may comprise a table-top assembly 631, a shelf assembly 630, one or more speaker assemblies 625 and/or a locking assembly 610. In some embodiments, the locking assembly 610 may tighten around an existing parasol pole 645 in order to hold the sun table power apparatus in place. In some embodiments, the speaker assembly may be located in a higher vertical position than the locking assembly 610. In some embodiments, the speaker assembly 625 may be connected to a top surface of the locking assembly 610. In some embodiments, the shelf assembly 630 may comprise an opening where a mobile communication device may be placed in order to charge. When the mobile communication device is placed in the opening of the shelf assembly 630, it is also protected from the sun and/or other environmental conditions. FIG. 6B illustrates a top perspective view of a sun table charging apparatus or device according to some embodiments. FIG. 6B illustrates the components or portions of the sun table apparatus illustrated in FIG. 6A. FIG. 6B also shows a top surface 635 of the sub table power apparatus, and the top surface 635 may include one or more solar cells or solar cell arrays. In some embodiments, the top surface 635 and the table top assembly 631 may be circular and/or oval in shape.

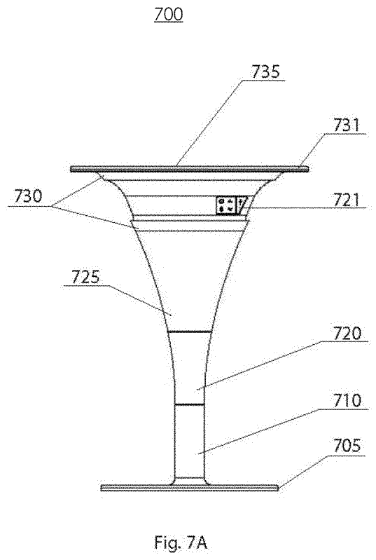

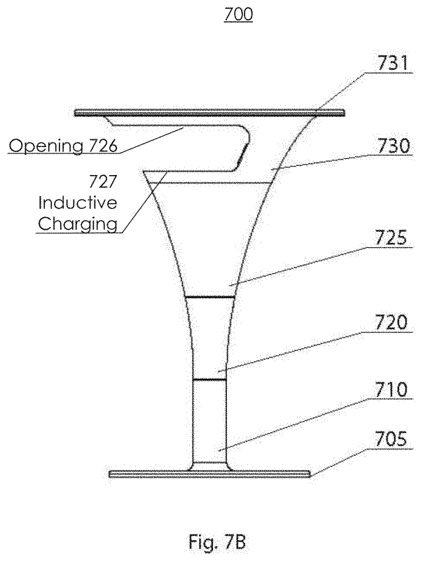

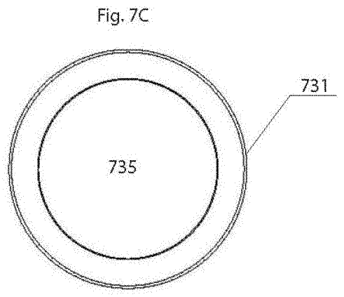

FIG. 7A illustrates a side view of a free-standing sun table power charging apparatus including a one-sided shelf assembly according to some embodiments. FIG. 7B illustrates a front view of a free-standing sun table power charging apparatus including a one-sided shelf assembly according to some embodiments. FIG. 7C illustrates a top view of a free-standing sun table power charging apparatus including a one-sided shelf assembly according to some embodiments. In some embodiments, the opening allows a user or operator to easily slide in a mobile communication device for charging or powering on the shelf assembly. In some embodiments, the free-standing, sun table charging device includes a top surface 735 which includes one or more solar cells or arrays (not shown), a table top or top assembly 731, a one-sided shelf assembly 730, a speaker assembly 725, an upper center support assembly 720, a lower center support assembly 710 and/or a base assembly or base plate 705. In some embodiments, the one-sided shelf assembly may comprise control buttons or panels 721 to allow operation of the free-standing sun table. In some embodiments, one or more induction charging assemblies or plates 727 will be on a top surface of the opening of the shelf assembly 730. In some embodiments, because the shelf assembly 730 is one-sided, a user can easily place the mobile communication device in the opening 726 and onto one of the one or more induction charging assemblies or plates 727. In some embodiments, the lower center support assembly 710 is attached or coupled to the base plate 705 and the upper center support assembly 720 is attached or coupled to the lower center support assembly 710. In some embodiments, the speaker assembly 725 may be connected or coupled to the upper center support assembly 720. In some embodiments, the shelf assembly 730 may be coupled to the speaker assembly 725. In some embodiments, a table-top or table assembly 731 may be connected, attached or coupled to the shelf assembly 730. In some embodiments, the electronic or mechanical components described above may be located in the shelf assembly 730, the speaker assembly 725, the upper center support assembly 720 and/or the lower center support assembly 710. In some embodiments, the sun table 700 is free-standing and thus can be utilized on any level surface including, but not limited to, cement, asphalt, grass and/or dirt.

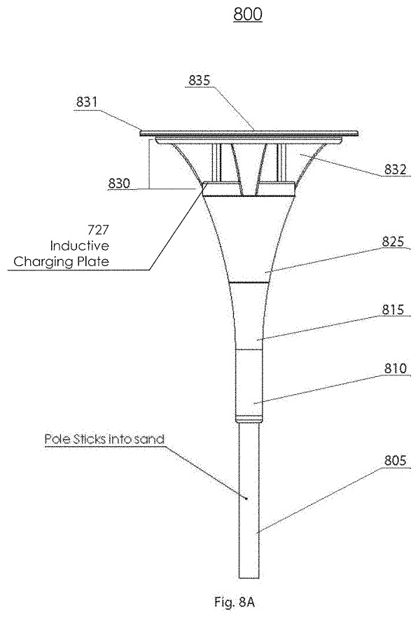

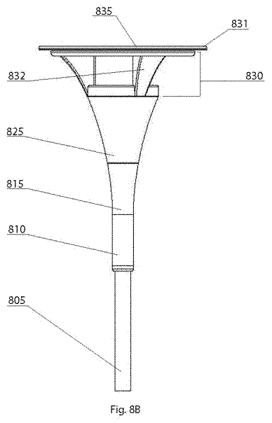

FIG. 8A illustrates a front view of a sun table charging apparatus to be utilized in loose ground environments such as sand according to some embodiments. FIG. 8B illustrates a side view of a sun table charging apparatus to be utilized in loose ground environments such as sand according to some embodiments. In some embodiments, the sun table charging apparatus 800 includes a top surface 835, a table top or table assembly 831, a plurality of vertical connectors 832 which are part of a shelf assembly 830, one or more speaker assemblies 825, an upper center support assembly 815, a lower center support assembly 805 and/or a pole or shaft 805 that may be inserted into the loose ground (e.g., the sand) in order to allow the sun table charging apparatus to be utilized in an outdoor environment such as the beach. In some embodiments, the pole or shaft 805 may be made of plastic, fiberglass and/or a metal material. In some embodiments, the pole or shaft 805 may be connected to lower center support assembly 810 and the lower center support assembly 810 may be connected or attached to the upper center support assembly 815. In some embodiments, a diameter of the pole or shaft 805 may be smaller than a diameter of the lower center support assembly 810 or the upper center support assembly 815. In some embodiments, the speaker assembly 825 may be connected, coupled or attached to the upper center support assembly 815 and the speaker assembly may be connected, couple or attached to the shelf assembly 830. In some embodiments, the plurality of vertical connectors 832 may be coupled the speaker assembly 825 or a bottom portion of the shelf assembly to the top portion of the shelf assembly 830. In some embodiments, the plurality of vertical connectors 832 leave openings so that a user or operator may place a mobile communication device onto a bottom portion of the shelf assembly 830. In some embodiments, a top surface of a bottom portion of the shelf assembly 830 may have inductive charging assemblies or plates that may power up the mobile communication device. In some embodiment, the shelf assembly 830 may be coupled to a table assembly or tabletop 831, which has a top surface 835 (where the top surface includes one or more solar cells or arrays).

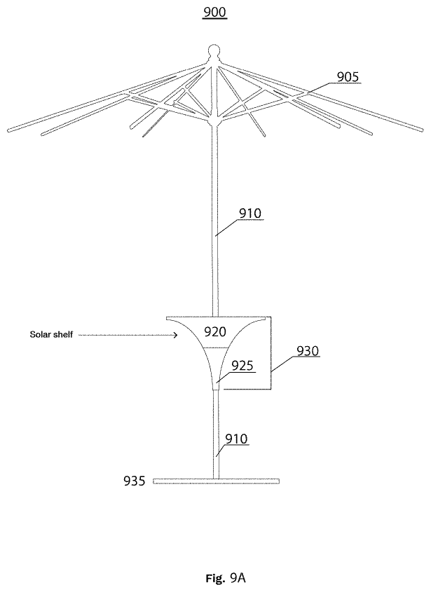

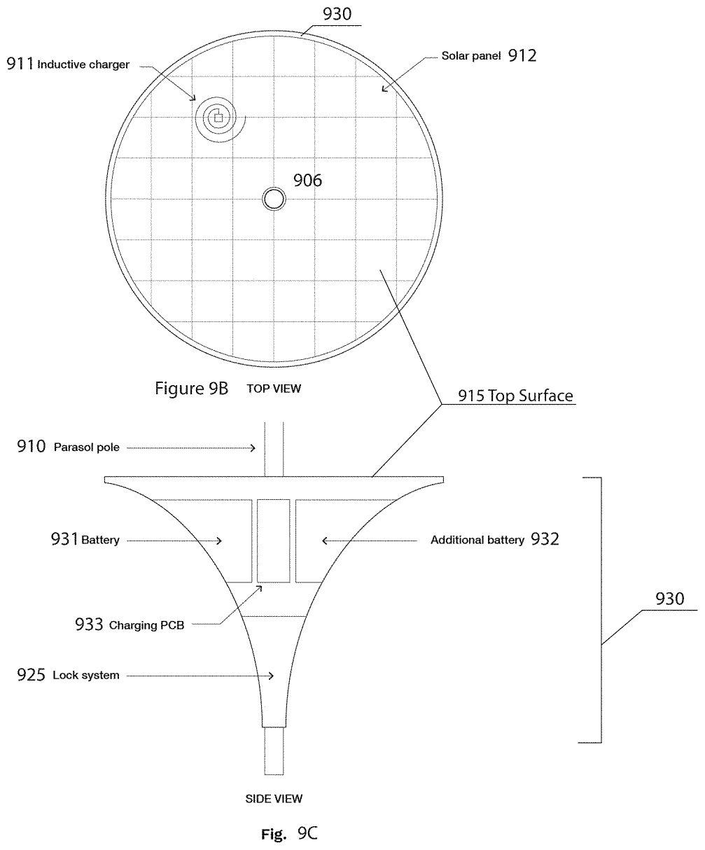

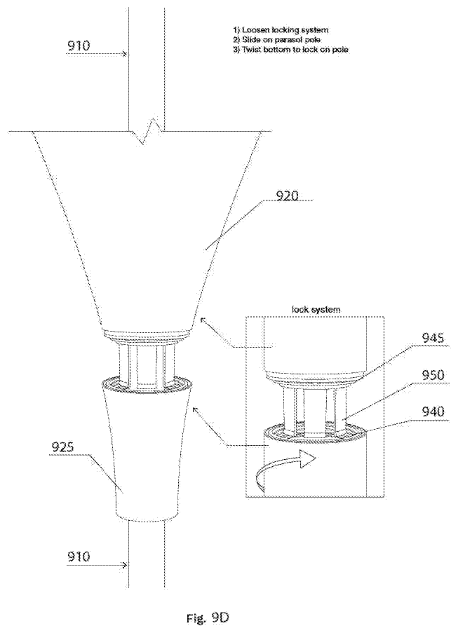

FIG. 9A illustrates a parasol with an attachable or connectable solar shelf according to some embodiments. In some embodiments, a parasol or umbrella with a solar shelf 900 may include a frame (or arms) 905, a central support pole or assembly 910, a base assembly 935 and a connectable or attachable solar shelf 930. In some embodiments, the connectable or attachable solar shelf 930 may include a top portion 920 and a bottom portion 925. In some embodiments, the connectable solar shelf 930 may be attached to the central support pole or assembly 910 and may be connectable to existing parasol poles.

FIG. 9B illustrates a top view of a solar shelf or sun table according to some embodiments. In some embodiments, a top surface of a solar shelf 930 may comprise one or more inductive chargers 911 (e.g., one or more inductive charging plates), one or more solar cells or solar cell arrays 912, and an opening or hole 906 in the top surface of the solar shelf 930. In some embodiments, a user or operator may place a mobile computing or communication device or other electronic devices (which have inductive charging capability or functionality) on the inductive charger 911 in order to power the mobile computing or communication device or other electronic device. In some embodiments, there may be multiple inductive chargers or charging assemblies 911 on a top surface of the solar shelf or sun table 930.

FIG. 9C illustrates a cut away side view of the attachable or connectable solar shelf according to some embodiments. In some embodiments, the solar shelf 930 may be attached or connected to a parasol pole 910 at a bottom portion of the solar shelf 930. In some embodiments, the solar shelf 930 may comprise a top surface 915 of a solar shelf, one or more renewable power sources 931 and 932 (e.g., rechargeable batteries), a charging assembly or printed circuit board 933, and/or a locking system 925. In embodiments the one or more solar cells or solar panels 912 may gather or capture light from the sun, generate power which is then transferred to the charging assembly or charging PCB 933. In some embodiments, the charging assembly 933 may transfer power to the one or more renewable power sources 931 and 932. In some embodiments, the one or more renewable power sources 931 and 932 (e.g., renewable batteries) may provide power to the one or more inductive chargers 911 at the top surface 915 of the solar shelf. In embodiments, the charging assembly 933 may provide power directly to the one or more inductive chargers or inductive charging assembly 911 at the top surface 915 of the solar shelf.

FIG. 9D illustrates a side view of a top section and a bottom section of the attachable or connectable solar shelf according to embodiments. In some embodiments, a top section 920 of the solar shelf may be attached to a bottom section 925 of the solar shelf and the bottom section 925 of the solar shelf may be connected or attached to the parasol pole 910. In embodiments, a lock system may comprise one or more tapered ridges 945 on an inner bottom portion of the top section 920 and one or more recessed channels 940 on an inner top portion of the bottom section 925. In some embodiments, the bottom section 925 of the solar shelf may be twisted or rotated to that the tapered ridges 945 fit into the recessed channels 940 for a tight seal or tight connection. In embodiments the locking system may also include one or more vertical plates or vertical connectors 950 (e.g., there are three vertical plates illustrated in FIG. 9D), that press against the parasol pole 910 to connect or attach the solar shelf to the parasol pole. In embodiments, the one or more vertical plates or vertical connectors 950 may have ridges or notches or a material (e.g., rubber or foam) that may be pressed against the parasol pole 910 when the locking system is engaged (e.g. the bottom section 925 of the solar shelf is twisted and/or locked to the top section 920 of the solar shelf as well as attached or connected to the parasol pole.

As detailed above, the computing devices and systems described and/or illustrated herein broadly represent any type or form of computing device or system capable of executing computer-readable instructions, such as those contained within the modules described herein. In their most basic configuration, these computing device(s) may each comprise at least one memory device and at least one physical processor.

The term “memory” or “memory device,” as used herein, generally represents any type or form of volatile or non-volatile storage device or medium capable of storing data and/or computer-readable instructions. In one example, a memory device may store, load, and/or maintain one or more of the modules described herein. Examples of memory devices comprise, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In addition, the term “processor” or “physical processor,” as used herein, generally refers to any type or form of hardware-implemented processing unit capable of interpreting and/or executing computer-readable instructions. In one example, a physical processor may access and/or modify one or more modules stored in the above-described memory device. Examples of physical processors comprise, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

For example, a “mobile communication device” may refer to a device or apparatus that comprises one or more processors, one or more memory devices, communication circuitry (such as wired or wireless communication transceivers), a display or screen, a power source, a power source interface, one or more sensor assemblies and/or one or more image sensors. In some embodiments, one or more image sensors may be one or more cameras, CCD arrays or similar devices. The mobile communication device may also comprise computer-readable instructions stored in the one or more memory devices that are executable by the one or more processors to perform certain features or functions as described herein. The mobile communications device may be portable and/or handheld and may be able to be moved easily from location to location. The terms smartphone, mobile phone, mobile computing device, portable computing device, mobile communications device and portable communications device may be utilized interchangeably through the specification. The mobile communication device may be a smartphone, a mobile phone, a tablet computing device, a laptop computing device, a PDA device, and/or wearable computing device (if aligned to fit and coupled to the corneal topography system).

In addition, one or more of the devices described herein may transform data, physical devices, and/or representations of physical devices from one form to another. Additionally, or alternatively, one or more of the modules recited herein may transform a processor, volatile memory, non-volatile memory, and/or any other portion of a physical computing device from one form of computing device to another form of computing device by executing on the computing device, storing data on the computing device, and/or otherwise interacting with the computing device.

The term “computer-readable medium,” as used herein, generally refers to any form of device, carrier, or medium capable of storing or carrying computer-readable instructions. Examples of computer-readable media comprise, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The above disclosure is sufficient to enable one of ordinary skill in the art to practice the claimed subject matter, and provides the best mode of practicing the claimed subject matter presently contemplated by the inventor. While there is provided herein a full and complete disclosure of the preferred configurations of this claimed subject matter, it is not desired to limit the claimed subject matter to the exact construction, dimensional relationships, and operation shown and described. Various modifications, alternative constructions, changes and equivalents will readily occur to those skilled in the art and may be employed, as suitable, without departing from the true spirit and scope of the claimed subject matter. Such changes might involve alternative materials, components, structural arrangements, sizes, shapes, forms, functions, operational features or the like. The claimed subject matter has been described herein using specific embodiments for the purposes of illustration only. It will be readily apparent to one of ordinary skill in the art, however, that the principles of the claimed subject matter can be embodied in other ways. Therefore, the claimed subject matter should not be regarded as being limited in scope to the specific embodiments disclosed herein, but instead as being fully commensurate in scope with the following claims.

1. A mobile communication device charging apparatus, comprising:
a base assembly;
a central support assembly connected to the base assembly;
an electronics housing connected to the central support assembly;
a speaker housing connected to the electronics housing;
a shelf assembly connected to the speaker housing; and
a table assembly connected to the shelf assembly, the table assembly comprising one or more solar cells or arrays, the one or more solar cells or arrays to capture sunlight in order to generate power for the charging apparatus,
wherein the shelf assembly includes an opening and a lower surface, the lower surface including inductive charging assemblies to charge a mobile communication device placed thereon and
wherein a top surface of the shelf assembly protects the mobile communication device from sunlight when the mobile communication device is placed on the lower surface.

2. The mobile communication device charging apparatus of claim 1, the electronics housing further comprising a universal serial bus (USB) charger to allow the electronics housing to power USB devices.

3. The mobile communication device charging apparatus of claim 1, further comprising one or more charging assemblies, the one or more charging assemblies to receive power from the one or more solar cells or arrays.

4. The mobile communication device charging apparatus of claim 1, the electronics housing further comprising one or more rechargeable power sources, the one or more rechargeable power sources to receive power from the one or more charging assemblies.

5. The mobile communication device charging apparatus of claim 4, further comprising a power input port, the power input port receiving power from an external source to provide power to the one or more rechargeable power sources.

6. The mobile communication device charging apparatus of claim 4, the one or more rechargeable power sources to provide power for electronic components within the mobile communication device charging apparatus.

7. The mobile communication device charging apparatus of claim 1, further comprising one or more audio receivers and one or more speakers, the audio receivers coupled to one or more speakers in the speaker housing.

8. The mobile communication device charging apparatus of claim 1, further comprising one or more wireless communication transceivers, the one or more wireless communication transceivers to receive commands, instructions, messages and/or files from external computing devices.

9. The mobile communication device charging apparatus of claim 1, the electronics housing further comprising one or more processors, one or more memory devices, and/or computer-readable instructions stored in the one or more memory devices and executable by one or more processors to perform operations for the mobile communicating device charging apparatus.

10. The mobile communication device charging apparatus of claim 9, further comprising one or more microphones, the one or more microphones to capture sound or audio in an area around the mobile communication device charging apparatus.

11. The mobile communication device charging apparatus of claim 10, wherein the computer-readable instructions executable by the one or more processors receive the captured sound, analyze the captured sound to create commands, messages and/or instructions, and communicate the created commands, messages or instructions to other components of the mobile communication device charging apparatus.

12. The mobile communication device charging apparatus of claim 1, further comprising one or more environmental sensor assemblies, the one or more environmental sensor assemblies to capture measurements in an area around the mobile communication device charging apparatus.

13. The mobile communication device charging apparatus of claim 1, further comprising one or more proximity sensors, the one or more proximity sensors to detect movement in an area around the mobile communication device charging apparatus.

14. The mobile communication device charging apparatus of claim 1, further comprising one or more lighting assemblies, the one or more lighting assemblies to provide light to an area around the mobile communication device charging apparatus.

15. The mobile communication device charging apparatus of claim 1, further comprising one or more imaging devices, the one or more imaging devices to capture images and/or video of an area around the mobile communication device charging apparatus.
